(19) United States
(12) Patent Application Publication
(10) Pub. No.: US 2026/0217042 A1
(43) Pub. Date: Jul. 30, 2026

(54) DECORATIVE ELEMENT COMPRISING AN ENGINEERED STONE AND A METHOD MANUFACTURING A DECORATIVE ELEMENT COMPRISING AN ENGINEERED STONE

(71) Applicant: DAL-TILE, LLC, Dallas, TX (US)

(72) Inventors: Rahul PATKI, Dallas, TX (US); Claudio CASELLI, Dallas, TX (US)

(21) Appl. No.: 19/461,633

(22) Filed: Jan. 27, 2026

Related U.S. Application Data
(60) Provisional application No. 63/750,323, filed on Jan. 28, 2025.

(51) Int. Cl. B41M 5/00

(52) U.S. Cl. CPC B41M 5/007; B41M 5/0047

(57) ABSTRACT

A decorative element comprising a body made of engineered stone, said engineered stone comprising a mineral filler and a polymeric binder, wherein the decorative element comprises a first decorative pattern on at least one surface of said body, wherein said first decorative pattern is inkjet printed and is formed by one or more sublimation dyes, wherein at least one of said dyes is black.

### CROSS-REFERENCE TO RELATED APPLICATIONS

This application claims the benefit of U.S. Provisional Application No. 63/750,323, filed on Jan. 28, 2025, and entitled “A decorative element comprising an engineered stone and a method manufacturing a decorative element comprising an engineered stone”, which is incorporated herein by reference in its entirety for all purposes.

### BACKGROUND OF THE DISCLOSURE

The present invention relates to a decorative element comprising an engineered stone, for example kitchen or bathroom top. The invention further relates a method for manufacturing said decorative element.

An engineered stone, also known as quartz, is a composite material that comprises an inorganic filler like crushed stones, sands or other minerals but also recycled ceramic or glass, bonded by means of a cured resin, preferably a thermosetting resin like polyester resin. More in detail, with engineered stone is intended a composite material formed by an inorganic filler or a stone like material bonded together by means of a cured binder that it is cured at low temperature, wherein with low temperature is intended a temperature below 500° C. Engineered stone of the invention are preferably those having a porosity below 0.5%, in particular those obtained through compaction of binder and filler under application of vibration and vacuum. This kind of engineered stone is also known as Bretonstone®.

Several possibilities for forming décor in engineered stone are known. Some of these possibilities require distribution and or mixing of pigment in the mass of filler and binder before curing the binder itself to obtain an aspect imitating a natural stone having flakes or veins. Examples of these possibilities are disclosed in WO 2007/138529 or WO 2009/010406. Nevertheless, the abovementioned possibilities provide for a limited variation in the possible achievable décor, a limited resolution of the achievable décor and, at least in some cases, they are subjected to a certain degree of randomness in the formation of the décor caused by the compaction of the mass under vacuum and vibration that may lead to leads to uncontrolled displacement of the pigments.

To improve the variability, reproducibility and resolution of the décor, inkjet printing has been proposed to form a décor on at least one surface of the decorative element. Example of decorative element comprising engineered stone decorated by means of inkjet printing and of method for manufacturing said decorative elements are shown in U.S. Pat. No. 11,628,593, WO 2024/003735, WO 2024/121738. In particular, the above-mentioned examples relate to printing decor on the surface of the decorative elements by jetting droplets of sublimation inks. Unfortunately, sublimation inks show a limited resistance under ultraviolet (UV) radiation and sun light.

### BRIEF SUMMARY OF THE DISCLOSURE

The present invention aims in the first place to provide an alternative decorative element, which, in accordance with several of its preferred embodiments, is directed to solve one or more of the problems arising in the state of the art.

Thereto, the present invention, according to its first independent aspect, concerns a decorative element comprising a body made of engineered stone, said engineered stone comprising a mineral filler and a polymeric binder, wherein the decorative element comprises a first decorative pattern on at least one surface of said body, wherein said first decorative pattern is inkjet printed and is formed by one or more sublimation dyes. With the characteristic that at least one of said dyes is black. During internal investigation, black dyes have shown higher color stability under exposure to UV radiation. The inventors have surprisingly found that by ensuring the presence of black dyes in the décor pattern, the deterioration of the first decorative pattern itself, even of other colors can be hidden or minimized.

In a first preferred embodiment of the first aspect, the first decorative pattern can be formed exclusively by the black dye.

In a second preferred embodiment of the invention, the first decorative pattern can be formed by a plurality of colored dyes in addition to the black dye. In particular said colors can be: white, yellow, cyan, magenta, red and/or green.

It is further preferable that, in case one or more colored dyes are used to form the décor pattern, each of said colored dyes is present in a maximum amount per unit area that is less than the maximum amount per unit area of the black dye. In particular, it could be preferable that said maximum amount per unit area of the colored dye is less than a half of the maximum amount per unit area of the black dye, even more preferable 20% or less of the maximum amount per unit area of the black dye. Inventors have found that by limiting the intensity of color different from black, if on one hand limit the variability of obtainable décor, on the other hand helps in hiding color deterioration and results in a final product showing an improved resistance to UV radiation.

In any of the embodiments of the first aspect, the decorative element can also comprise a second decorative pattern visible on the same surface provided with the first decorative pattern so that the second decorative pattern and the first decorative pattern combined form a final décor of the decorative element. The second decorative pattern is formed in the body and is preferably present through the thickness of the body, more preferably through more than a half of said thickness, for example through the entirety of it. The second decorative pattern is preferably formed by one or more pigments distributed according to a pattern. Pigments, i.e. solid colorants, show a higher durability and lightfastness, compared to dyes, i.e. liquid colorants. On the other hand, second decorative pattern made in the body can show a lower resolution and be less detailed than first decorative pattern made by inkjet printing.

In accordance with the first preferred embodiment of the first aspect, the second decorative pattern can be formed by a combination of multiple colors, whether or not comprising black, or by a single color, preferably different from black, and the first decorative pattern is formed by black dye. In this way, the final appearance of the decorative element can be formed by the combination of the second decorative pattern and of the décor pattern, so that the possible color fading caused by deterioration of the dye can have a more limited effect on the part of the décor of the decorative element having the larger color variation.

In accordance with its second independent aspect, the invention concerns a decorative element comprising a body made of engineered stone, said engineered stone comprising a mineral filler and a polymeric binder, wherein said body shows at least on its upper surface a second decorative pattern having a first average color, and wherein the decorative element comprises a first decorative pattern on at least said upper surface of said body, wherein said first decorative pattern is inkjet printed and wherein said first decorative pattern comprises a second average color, with the characteristic that the difference between the first and the second average color, measured as ΔE in the CIELAB system, is below 10, preferably below 7, even more preferably below 5. Inventors have found that by limiting the color difference between the second decorative pattern and the first decorative pattern it is possible to limit the visibility of any damage or deterioration of the décor pattern. Albeit not limited to, the solution of the second independent aspect is of particular interest when the first decorative pattern is formed by means of dyes, instead of pigment, more in particular sublimation dyes. Dyes are more sensitive to ultraviolet radiation than pigment and the solution of the first independent aspect can lead to an improved resistance of the decorative element. Sublimation dyes are even more sensitive to UV radiation than other kinds of dyes and it is with these kinds of dyes that the solution is of particular interest. In the less preferred embodiment where pigments are used, the solution is more interesting in combination with organic pigments rather than inorganic pigments, as the firsts are more susceptible to UV deterioration. It is noted that the decorative element of the second aspect can comprise any of the characteristics of the decorative element of the first aspect.

In the most preferred embodiments, in accordance with any of the aspects, the first decorative pattern and/or the second decorative pattern can imitate a natural stone, preferably a marble or a granite.

Preferably, in accordance with any of the aspects, the second decorative pattern and the first decorative pattern can be complementary to each other, meaning that they both comprise features of a final décor of the decorative element so that said final décor results from the juxtaposition of the second decorative pattern and of the décor pattern. For example, one of the two décors can comprise detailing features that enrich or improve the other décor. For example, the second decorative pattern can imitate a marble having veins and the first decorative pattern can be formed by veins, flakes and or shades so that the resulting final décor shows a more realistic imitation of the marble.

In any of the preceding aspect or embodiments, the first decorative pattern is preferably formed by sublimation dyes. In this case, the dyes permeate the surface of the body of the decorative element, for example penetrate the surface of the body of penetration depth, for example said penetration depth can be equal or more than 10 microns, for example equal or more than 50 microns. Said penetration depth can be equal or lower than 500 microns. On the other hand, if the decor pattern is formed using radiation curable ink, like for example UV curable inks or infrared curable inks, the inks can form a film on the surface of the body of the decorative element. In this case it is possible that the decorative element further comprises one or more additional films or coating on the surface having the décor pattern, for example a primer layer and/or a protective layer respectively below and above said film formed by the decorative pattern.

In accordance with any of the above mentioned independent aspects, the body can be made of an engineered stone and comprise a mineral fille and an organic binder. In the context of the present invention, the engineered stone can show a porosity below or equal 0.1%. The mineral filler is preferably at least 80% by weight of the engineered stone, preferably more than 85% and more preferably more than 90%. The organic binder being less than 20% by weight of the engineered stone, preferably less than 15% and more preferably less than 10%. The engineered stone being obtained starting from a mixture comprising said mineral filler and said organic binder.

In the preferred embodiment the mineral filler comprises mineral material like any kind of stone, sands and/or siliceous mineral material, for example quartz, silica sand, clay, feldspar, cristobalite, granite, talc or calcareous mineral material, for example, calcium carbonate, marble, gypsum. The mineral filler can also comprise ceramic, glass, metals and other inorganic material, for example recycled materials. The mineral filler can be in form of powder, granules, shards, grains, aggregates or any other particulate form although granules and powder forms are preferred. Preferably, the mineral filler is in powder form having an average particle dimension lower than 45 μm, preferably lower than 20 μm. The mineral filler can represent at least 80% by weight of the mixture, preferably more than 85% and more preferably more than 90% by weight of the mixture. According to another embodiment of the invention, the mineral filler can be in form of aggregates, grains and/or granules having a particles size distribution between 0.1 and 6.5 mm, preferably between 0.1 and 2 mm, 0.1 and 0.7 mm. In the most preferred embodiment, the mineral filler can be composed by a combination of powder and grains, for example said combination can comprise at least 60% weight of grains and/or granules and between 20 to 35% weight of powder form wherein, for example, the granules have a particles size distribution between 0.1 and 6.5 mm and the powder have an average particle dimension lower than 45 μm, preferably lower than 20 μm. In the most preferred embodiment of the invention the mineral filler can be composed for its majority, i.e. at least 50% weight, and more preferably mainly consists, of an inorganic material that is based on silicon (Si). Silicon based material like siliceous minerals and glass show a good affinity with the binder so that the final bonding can be improved.

In some embodiments, crystalline silica, feldspar or kaolin can constitute preferred choice for the mineral filler, or at least for a majority of the mineral filler, as they can show a relatively white color. In some embodiments, glassy and/or amorphous inorganic fillers can be preferred for forming the majority of the inorganic filler as they can reduce the amount of free crystalline silica dust in manufacturing and/or working of the engineered stone.

The organic binder is a curable substance that is configured to be cured thereby bonding together the particles of the stone or stone like material. The binder can be in any form, i.e. liquid, solid, gel or any form that is suitable to be mixed with the filler and to be homogeneously dispersed within. In some embodiments, powder form can be preferred as it reduces the possibility of contamination of the mixture from other substance, that can occur using wet form of binders. The organic binder is preferably a resin. In the most preferred example, the binder can be a thermosetting resin.

In the most preferred embodiment the organic binder comprises, preferably substantially consists of, polyester resin preferably unsaturated polyester resin. More in particular, said resin is a styrene-polyester copolymer, for example where unsaturated polyester is crosslinked with styrene. Less preferred alternative solutions for the binder comprise acrylic resin, epoxy resin, polyurethane, rubber, vinyl ester resin or the like. The binder is preferably less than 20% by weight of the mixture, preferably less than 15% and more preferably less than 10%. Polyester resins have shown a very high coupling capability with the inorganic filler.

In accordance with any independent aspect of the invention, it is preferable that the decorative element, and the body thereof, is in form of a slab. In this case the surface provided with the first decorative pattern is one of the main surfaces of the slab.

It is noted that the invention, according to its third independent aspect, can relate to a method for manufacturing a decorative element, wherein the method comprises:
providing a body made of engineered stone, said engineered stone comprising a mineral filler and a polymeric binder;
printing a first decorative pattern on a surface of said body by means of inkjet printing;

wherein said printing operation can be performed by jetting at least a black ink.

In some embodiments, said décor printing can be formed by means of a plurality of inks of different colors in addition to black ink. In this case, it is preferable that the f each of said inks of the plurality in addition to black ink is jetted with a maximum intensity below or equal to 30%, preferably below or equal to 20%. It is noted that the maximum intensity of the black ink can be set to 100%.

In a first possibility, said maximum intensity can be set in an image processing operation for forming an image file of the first decorative pattern or a control file of the printer. Said image processing operation can be performed by means of dedicated software like, for example, Photoshop® or Gimp®. For example, said image processing operation can be performed by a human operator or, in alternative embodiments, by a machine learning model.

In a second possibility, said maximum color intensity is obtained by using inks having a dye or pigment concentration being below or equal to 30%, preferably below or equal to 20% of the concentration of the dye or pigment concentration of the black ink. In this way the maximum amount of dye or pigment per unit area can be limited.

It is noted that the invention, in its fourth independent aspect, can relate to a method for manufacturing a decorative element, wherein the method comprises:
providing a body made of engineered stone, said engineered stone comprising a mineral filler and a polymeric binder;
determining a first average color of a surface of the body;
printing a first decorative pattern on a surface of said body by means of inkjet printing;

wherein said first decorative pattern comprises a second average color, and wherein the difference between the first and the second average color, measured as ΔE in the CIELAB system, is below 10, preferably below 7, even more preferably below 5.

In its preferred embodiment, the method of the fourth aspect, can comprise an image processing operation performed on an image file of the first decorative pattern or a control file of the printer. Said image processing operation can be performed by means of dedicated software like, for example, Photoshop® or Gimp®. For example, said image processing operation can be performed by a human operator or, in alternative embodiments, by a machine learning model.

In the method of the fourth embodiment, it is preferred that the first decorative pattern comprises a maximum color variation ΔEₘₐₓ, measured as ΔE in the CIELAB system, from the second average color below 15, more preferably below 10.

It is noted that the method of the third or fourth independent aspect is particularly interesting in combination with dye containing ink, preferably with sublimation ink.

The decorative element obtained by the method of the third and or of the fourth independent aspect, can comprise any of the features described in relation to the first and the second aspect.

In accordance with any of the third and fourth aspect of the invention, the steps of providing the body can comprise the below described sub-steps of: preparing a mixture comprising a mineral filler and an organic binder; compacting said mixture; curing said organic binder to obtain the engineered stone.

The method according to any of the third and second aspect, can comprise a step of preparing a mixture comprising the mineral filler and the organic binder as described above. The mixture can also comprise additive liker catalyst, colorants, adhesion promoters. The obtained mixture is provided in a mold, or a on a carrier, preferably having shapes and sizes similar to those of the final decorative element. In some embodiments one or more pigments are added to the mixture, preferably according to an at least partially predetermined pattern, in order to form the basic décor.

After the mixture has been provided in the mold or temporary carrier the sub-step of compacting the mixture can be performed. Preferably the compacting step is conducted under vacuum, i.e. vacuum is generated in the mold to help extracting air between the mixture particles. More preferably, vibration is applied to the mold or carrier during the compacting step thereby helping to compact of the mixture particles, so that the porosity of the engineered stone can be significantly reduced. According to a preferred embodiment both vacuum and vibration are applied to the mixture during the compacting. In this way, it is possible to obtain a very high degree of compaction of the mixture that after curing will lead to an extremely low porosity.

After the compacting step, the mixture in the mold or carrier is carried to a curing station for curing the organic binder. The cure of the binder can be preferably obtained by means of heating. In the preferred embodiment, the curing step is conducted at a temperature below 500° C., for example below 200° C., for example at room temperature. In particular, in the preferred example the curing step can be thermally activated and continues in an exothermic reaction. The activation of the curing of the binder can occur at a temperature below 100° C.

After curing the method can comprise a flattening step and/or a squaring step. Calibration and squaring are mechanical machining steps that have the scope of providing to the engineered stone the final desired shape and dimension. In particular, calibration has the scope of flattening one or both the main surfaces of the body made of engineered stone.

Preferably the step of forming said first decorative pattern is performed after said curing step, more preferably after said flattening and/or squaring step is performed.

In the preferred embodiments according to said third and fourth independent aspect, the method can comprise a step of polishing the surface of the body to be provided with the décor pattern, before printing the first decorative pattern itself, and/or a second step of polishing said surface of the body that has been previously provided with the décor pattern.

The decorative element and the method for manufacturing the decorative element can comprise any feature described in applications U.S. Pat. No. 11,628,593, WO 2024/003735, WO 2024/121738 which are herein incorporated by reference in their entirety.

With the intention of better showing the characteristics of the invention, in the following, as an example without any limitative character, several preferred embodiments are described with reference to the accompanying drawings, wherein:

### BRIEF DESCRIPTION OF THE DRAWINGS

FIG. 1 is a perspective view of a decorative element in accordance with the invention;

FIG. 2 shows some steps in a method for manufacturing the decorative element of FIG. 1;

### DETAILED DESCRIPTION OF THE DISCLOSURE

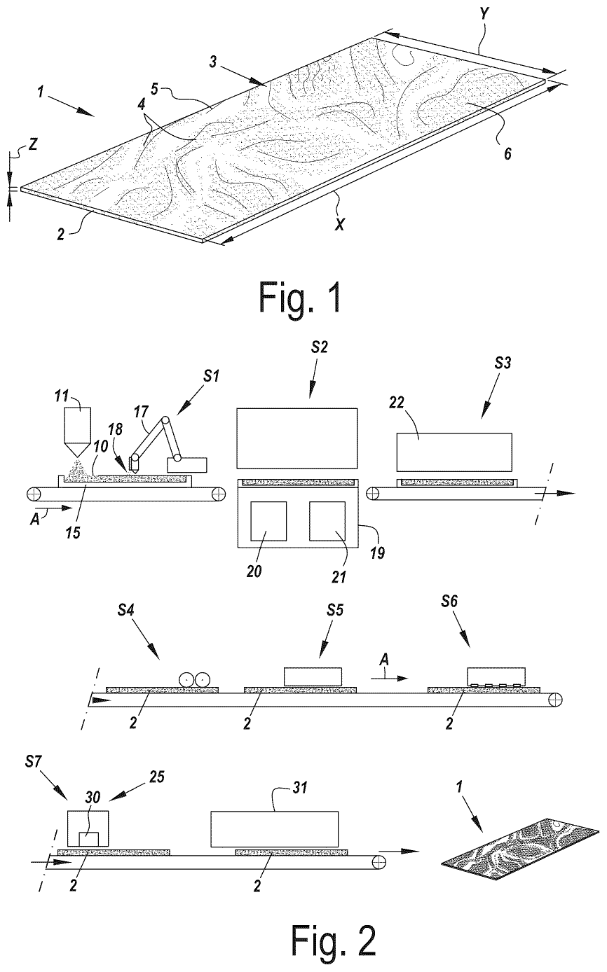

Referring to FIG. 1 it is shown a decorative element 1, in form of a slab and having a length X of at least 2 m, preferably at least 2.5 m, for example 3 m or more, and a width Y of at least 1 m preferably 1.5 m or more. Moreover, the decorative element 1 shows a thickness Z of at least 10 mm, preferably at least 20 mm for example 30 mm.

The decorative element 1 comprises a body 2 and an upper surface 3 upon which it is provided a décor 4, which in this case imitates a veined marble.

The body 2 is made of an engineered stone, wherein the engineered stone comprises mineral filler and a cured organic binder that bonds together the particles of mineral filler. The mineral filler is based on silicon oxide like silica or feldspar. The binder is a thermosetting resin and more in particular styrene-polyester copolymer, where unsaturated polyester is crosslinked with styrene.

The décor 4 is formed by a first decorative pattern 5 and a second decorative pattern 6. Said first and second decorative patterns 5, 6 are both visible on the upper surface 3.

The first decorative pattern 5 is a printed pattern that is present substantially only on the upper surface 3 of the body 2. Wherein substantially only it is meant that the first decorative pattern 5 is formed only on the upper surface 3 or penetrates into the upper surface 3 of the body 2 only for a few microns, preferably less than 1 mm from the upper surface 3.

The second decorative pattern 6 is a three-dimensional decoration that is present in the thickness of the substrate 2, preferably in the entirety of the thickness of the substrate.

The resolution of the first decorative pattern 5 is higher than that of the second decorative pattern 6.

The first decorative pattern 5 is formed by dyes, i.e. an organic colorant provided in liquid form. Preferably the dyes forming the first decorative pattern 5 adheres to the organic binder. In the preferred embodiment shown in the figure the first decorative pattern 5 represents details of the décor 6 like, thin veins, pores and/or flakes imitation.

In the preferred embodiment the first decorative pattern 5 is formed by a black dye and by other colored dyes different from black. For example, said colored dyes comprise cyan, magenta, yellow, green, white, red and/or brown dye. Most preferably, each of said colored dyes are cyan, yellow and magenta. In addition, in this embodiment, each of said colored dyes is present in a maximum amount per unit area that is less than the maximum amount per unit area of the black dye. Preferably, said maximum amount per unit area is expressed in grams per square meter. In the example, the maximum amount per unit area of the colored dye is less than a half of the maximum amount per unit area of the black dye.

In a variant of the example of FIG. 1, the first decorative pattern is formed exclusively by black dye.

In the example of FIG. 1, and in any embodiment of the invention the second decorative pattern is formed by one or more pigments distributed in the mineral filler. It is noted that also the color of the mineral filler itself can contribute to forming the second decorative pattern.

In the example shown in the figure the first decorative pattern comprises a first average color IavC and said second decorative pattern comprises a second average color IiavC. The difference between the first and the second average color, measured as ΔE in the CIELAB system, is below 5.

FIG. 2 shows some steps in a method, according to the invention, for manufacturing the decorative element of FIG. 1.

In a step S1 a mixture 10 is provided into a mold 15 for manufacturing the body 2. The mixture 10 comprises the mineral filler and the uncured organic binder.

The mineral filler is composed by a combination of powder and grains, for example said combination comprises at least 60 wt % of grains and/or granules and between 20 to 35 wt % of powder form wherein, for example, the granules have a particles size distribution between 0.1 and 6.5 mm and the powder have an average particle dimension lower than 45 μm, preferably lower than 20 μm. The filler is preferably at least the 80% by weight of the mixture, preferably more than the 85% and more preferably more than 90%.

The uncured organic binder is in powder form and form up to 10% by weight of the mixture.

The mixture 10 further comprises additives, like for example coupling agent, catalyst or crosslinkers.

In step S1 a first mixture 10, comprising a first color, for example comprising a first pigment, is deposited from a hopper 11 in the mold 15. One or more robotic arms create voids according to a pattern in the first mixture and deliver in said void a second mixture 18 comprising a second color, for example a comprising a second pigment to form the second decorative pattern 6.

The mixtures 10,18 in the mold 15 advance in an advancing direction A to a compacting station 19 for a compaction step S2. Said compacting station 19 comprises a vibrating unit 20 and a vacuum unit 21, for the application of vibration and vacuum on the mixture in the mold 15 that leads to the compaction thereof.

The mold 15 is then carried to a curing station 22 where the organic binder is cured in a curing step S3. The cure of the organic binder is activated at a temperature below 200° C. and then continues as an exothermic reaction.

After curing step S3 it is obtained a body 2, in form of a slab of engineered stone, which is now a coherent material having a porosity below 0.2%, is then extracted from the mold 15 and carried to multiple mechanical machining stations for finishing operations on the substrate 2.

In a step S4 the body 2 is flattened a led to its final thickness. Subsequently in a step S5 the body 2 is rectified so that it finally reaches the desired final dimension. It is noted that steps S4 and S5 can be inverted.

Subsequently, at least the upper surface 3 of the body 2 is mechanically treated in a polishing step S6. The polishing step S6 is conducted using abrasives having a CAMI Grit designation between 300 and 600 grits, preferably 400 grits.

The body 2 is then moved to a printing station 25 for printing the first decorative pattern 5 on the upper surface of the body 2 in a printing step S7. The printing station 25 comprises a multipass inkjet printer 30 adapted for printing a set of sublimation inks. The printer 30 is configured to print at least 4 inks, cyan, magenta, yellow and black, with the possible addition of one or more spot colors. The pigments are an inorganic ink. After printing the dyes included in the inks are fixed to the surface of the body by means of heating in a heating device 31.

The present invention is in no way limited to the hereinabove described embodiments, but such decorative element and method for manufacturing thereof may be realized according to different variants without leaving the scope of the present invention.

Further, as is clear from the content of the description, the present invention relates to one or more of the items as listed below:

1. A decorative element comprising a body made of engineered stone, said engineered stone comprising a mineral filler and a polymeric binder, wherein the decorative element comprises a first decorative pattern on at least one surface of said body, wherein said first decorative pattern is inkjet printed and is formed by one or more sublimation dyes, wherein at least one of said dyes is black.

2. The decorative element of claim 1, wherein the pattern is formed by a plurality of colored dyes.

3. The decorative element of claim 2, wherein said colors can be: white, yellow, cyan, magenta, red and/or green.

4. The decorative element of claim 2, wherein each of said colored dyes is present in a maximum amount per unit area that is less than the maximum amount per unit area of the black dye.

5. The decorative element of claim 4, wherein said maximum amount per unit area of the colored dye is less than a half of the maximum amount per unit area of the black dye, even more preferable 20% or less of the maximum amount per unit area of the black dye.

6. A decorative element comprising a body made of engineered stone, said engineered stone comprising a mineral filler and a polymeric binder, wherein said body shows at least on its upper surface a second decorative pattern having a first average color, and wherein the decorative element comprises a first decorative pattern on at least said upper surface of said body, wherein said first decorative pattern is inkjet printed and wherein said first decorative pattern comprises a second average color, with the characteristic that the difference between the first and the second average color, measured as ΔE in the CIELAB system, is below 10, preferably below 7, even more preferably below 5.

7. The decorative element according to claim 1, wherein the first decorative pattern is formed by means of dyes, instead of pigment, more in particular sublimation dyes.

8. The decorative element according to claim 1, wherein the first decorative pattern can imitate a natural stone, preferably a marble or a granite.

9. The decorative element according to claim 1, wherein the decorative element can comprise a basic décor, made in support and visible on an upper surface thereof, so that both the first decorative pattern and the second decorative pattern are visible on the upper surface of the decorative element.

10. The decorative element according to claim 9, wherein the second decorative pattern and the first decorative pattern are complementary to each other, in the sense that one of the two décors can comprise detailing features that enrich or improve the other décor.

11. The decorative element according to claim 9, wherein the second decorative pattern can imitate a marble having veins and the first decorative pattern can be formed by veins, flakes and or shades so that the resulting decorative element shows a more realistic imitation of the marble.

12. The decorative element according to any of claims from 9, wherein the second decorative pattern is formed by pigment distributed in the mass of filler and binder so that it is present not only on the upper surface of the support but can be present in the thickness thereof.

13. The decorative element according to claim 7, wherein the dyes permeate the surface of the support of the decorative element, for example penetrate the surface of the support of penetration depth, for example said penetration depth can be equal or more than 10 microns, for example equal or more than 50 microns.

14. The decorative element according to claim 13, wherein said penetration depth can be equal or lower than 500 microns.

15. A method for manufacturing a decorative element, wherein the method comprises:
providing a body made of engineered stone, said engineered stone comprising a mineral filler and a polymeric binder;
printing a first decorative pattern on a surface of said body by means of inkjet printing;
wherein said printing operation can be performed by jetting at least a black ink.

16. The method according to claim 15, wherein said décor printing can be formed by means of a plurality of inks of different colors in addition to black ink.

17. The method according to claim 16, wherein each of said inks of the plurality in addition to black ink is jetted with a maximum intensity below or equal to 30%, preferably below or equal to 20%.

18. The method according to claim 16, wherein the maximum intensity of the black ink can be set to 100%.

19. The method according to claim 17, wherein said maximum intensity can be set in an image processing operation for forming an image file of the first decorative pattern or a control file of the printer.

20. The method according to claim 19, wherein said image processing operation can be performed by means of dedicated software like, for example, Photoshop® or Gimp®.
